(19) United States
(12) Patent Application Publication
(10) Pub. No.: US 2019/0266929 A1
(43) Pub. Date: Aug. 29, 2019

(54) FRAMEWORK FOR A LIGHTED STRUCTURE, AND LIGHTED STRUCTURE COMPRISING SUCH A FRAMEWORK

(71) Applicant: DUO INDUSTRIE, Lansargues (FR)

(72) Inventors: Philippe BEILLE, Calvisson (FR); Antoine COPIN, Montpellier (FR); Loic TONI, Saint Christol (FR)

(21) Appl. No.: 16/284,778

(22) Filed: Feb. 25, 2019

(30) Foreign Application Priority Data
Feb. 26, 2018 (FR) 1851652

(51) Int. Cl. G09F 13/04; G09F 13/22; F21V 15/01

(52) U.S. Cl. CPC G09F 13/0413; G09F 13/22; G09F 2013/0445; G09F 2013/222; F21V 15/01

(57) ABSTRACT

A framework for a lighted structure, is provided, formed at least partially by tubes, called framework tubes, assembled together demountably or detachably, at least one of the framework tubes, called illuminated framework tube, includes at least one light source incorporated into the illuminated framework tube. Also provided is a lighted structure made of such a framework.

### BACKGROUND

The present invention relates to a framework for a lighted structure. It also relates to a lighted structure, such as an illuminated box, an illuminated sign, an illuminated wall, an illuminated stand, etc. comprising such a structure.

The field of the invention is the field of lighted structures such as illuminated boxes, illuminated signs, etc., comprising a framework, and in particular a framework that is self-supporting or suspended or also incorporated into a stand.

Many architectures currently exist for exhibition stands, boxes or signs, making it possible to erect and dismantle these structures more or less rapidly for temporary events, such as an exhibition for example. Most of the time, these structures are composed of a framework and a trim element, partially or totally surrounding said framework.

These structures are becoming more and more sophisticated and provide numerous functionalities, such as for example the possibility of illuminating them.

A first lighting solution is to provide external light sources lighting one or more faces of the structure externally. These solutions are complex, take up space, and are time-consuming to install on site. In addition, these solutions provide non-uniform lighting, creating halos, so that the quality of the lighting is not satisfactory.

A second lighting solution is to provide light sources placed within the inner volume of the structure. This second solution takes up less space, since it makes use of the inner volume of the structure. However, this second solution is still time-consuming and difficult to install on site, and difficult to transport. In addition, the lighting obtained can be of poor quality and provides mediocre results in some cases.

An aim of the present invention is to overcome the aforementioned drawbacks.

Another aim of the invention is to propose an integrated lighted framework for a lighted structure, that is easier and quicker to install on site.

Another aim of the invention is to propose an integrated lighted framework for a lighted structure, that is more lightweight.

Another aim of the invention is to propose an integrated lighted framework for a lighted structure, that is stronger, takes up less space and is easier to transport.

Yet another aim of the invention is to propose an integrated lighted framework for a lighted structure, that provides better quality lighting.

### SUMMARY

The invention proposes to achieve at least one of the aforementioned aims by means of a framework for a lighted structure, in particular a structure of the illuminated box or illuminated sign or illuminated wall type, said framework being at least partially formed by tubes, called framework tubes, assembled together demountably or detachably. The framework according to the invention is characterized by the fact that at least one of said framework tubes, called illuminated framework tube, comprises at least one light source incorporated into said illuminated framework tube.

Thus, the invention proposes a framework in which one or more light sources, and in particular all the light sources, are incorporated into the tubes forming the framework. As a result, the light sources can be incorporated into the tubes during manufacture thereof or at the factory. The framework according to the invention is thus easier and quicker to install on site.

In addition, as the light sources are incorporated into the tubes forming the framework, they are better protected against external impacts, which makes the framework more robust. Furthermore, the framework is easier to transport, as no light source is handled independently of the elements of the framework.

Furthermore, as the framework is formed by tubes, which are hollow by definition, it is more lightweight and has a better weight/inertia ratio.

Finally, the fact of positioning a light source in a tube makes it possible to “strengthen” this light source and thus to avoid, or at least to reduce, “spotting” and to have good quality lighting that is more pleasant and more effective.

In particular, the framework can be used to tension a display or to support an accessory such as a television screen.

The framework creates an architectural element that can be straight, parallelepiped, or comprise curves.

At least one light source of at least one illuminated framework tube can be oriented in a direction, called direction of lighting, that is parallel or tangential or even oblique with respect to a surface to be illuminated. In particular, according to a non-limitative embodiment, the direction of lighting can be:
perpendicular to said illuminated framework tube; and
parallel to the surface to be lighted, or tangential/oblique, with respect to the surface to be lighted.

At least one light source of at least one illuminated framework tube can provide direct lighting or indirect lighting.

In a particularly preferred, but in no way limitative, embodiment, for at least one, in particular each, illuminated framework tube, the light source is fully integrated into said illuminated framework tube so that is does not project from said tube.

Such an architecture makes it possible to better protect the light source(s).

Advantageously, the framework according to the invention can comprise several illuminated framework tubes each comprising at least one integrated light source.

Thus, the lighting obtained can be stronger or better distributed.

For example, the framework according to the invention can comprise illuminated framework tubes placed facing one another at the level of two opposite walls/faces of said framework.

According to another example, the framework according to the invention can comprise an illuminated framework tube for each of its faces/walls.

According to yet another example, the framework according to the invention can comprise illuminated framework tubes along the periphery of said framework.

According to yet another example, the framework according to the invention can comprise illuminated framework tubes that are aligned, in particular parallel to one another, in one direction, for example vertical or horizontal.

Alternatively, the framework according to the invention can comprise a single illuminated framework tube.

According to an advantageous, but non-limitative, embodiment, at least one illuminated framework tube lighting a wall/face of said framework can be provided on another wall/face of said framework, at a distance from an edge connecting said other wall/face to said lighted wall/face.

Thus, the light source(s) are distanced from the illuminated wall/face, which makes it possible to have more uniform lighting, with a better result.

In this embodiment, the illuminated framework tube can be located between the edges of said other wall/face or form an edge of said other wall/face opposite to the lighted wall/face.

Preferentially, the illuminated framework tube can be parallel to the wall/face of the framework lighted by said illuminated framework tube.

Advantageously, at least one, in particular each, illuminated framework tube can comprise a lighting support, arranged in said illuminated framework tube, and on which is arranged the light source incorporated into said illuminated framework tube.

Thus, it is possible to arrange the light source on the support and then to place said lighting support in the framework tube. The manufacture/production of each illuminated framework tube and of the framework is thus simplified.

The lighting support can be detachable or demountable with respect to the framework tube, so that it can be removed without damaging the framework tube.

Thus, the framework according to the invention makes it possible to produce customizable lighting, by modifying the lighting as desired.

According to a particular embodiment, at least one, in particular each, lighting support can have a “U”-shaped cross section.

Such a “U”-shaped cross section allows easy positioning of the light source and holds the light source in place during handling of the lighting support and of the illuminated framework tube in which said lighting support is incorporated.

According to a particular embodiment, the lighting support arranged in an illuminated framework tube can be inserted into said illuminated framework tube in a longitudinal direction of said illuminated framework tube, in particular from one end of said illuminated framework tube.

Thus, it is not necessary to provide for a specific insertion opening for the insertion of the lighting support into the framework tube, which simplifies the architecture thereof, but also avoids detracting from the mechanical strength of said tube.

At least one, in particular each, light source, placed in an illuminated framework tube, can be formed by several light emitters.

In particular, at least one, in particular each, emitter can be a diode or LED, or also a neon light or a bulb.

The emitters can be mounted in series or in parallel, and be supplied via a single electrical cord.

The electrical cord supplying a light source, or the light emitters forming the light source, can run within the illuminated framework tube incorporating said light source, up to said light source.

In particular, an electrical cord can run within a framework tube connected to the illuminated framework tube into which the light source that it is to supply is incorporated.

At least one, in particular each, illuminated framework tube can comprise one or more openings, each provided facing a light emitter, or a group of several light emitters.

Such an architecture makes it possible to better retain the mechanical strength of an illuminated framework tube, when the latter incorporates a light source comprising emitters distributed over a significant length of said illuminated framework tube.

Advantageously, at least two framework tubes can be assembled together by a detachable connector that is independent of said tubes.

Alternatively, at least two framework tubes can be assembled together by complementary connectors, provided on the assembly ends of said tubes.

In all cases, according to a characteristic that is optional but particularly advantageous, all the tubes forming the framework, including the illuminated framework tubes, can be assembled together by similar or identical connectors.

According to a non-limitative embodiment, at least one framework tube can be made of aluminium.

According to a non-limitative embodiment, at least one framework tube can have a rounded or circular cross section.

Alternatively, at least one framework tube can have a rectangular, square, triangular, etc. cross section.

According to another aspect of the same invention, a structure is proposed comprising a framework according to the invention.

The structure according to the invention can also comprise a trim element, placed on a part or the totality of said framework.

The trim element can be presented in particular in the form of a fabric.

Preferentially, the trim element is flexible.

The trim element can be painted or not, printed or not.

The trim element can be produced from any suitable material, for example from a textile.

According to an advantageous characteristic, the trim element can be extensible or elastic.

Such an extensible trim element can be obtained by a knitted fabric, the stitching making the trim element extensible. In this case, the trim element can be produced from polyester, polyamide, cotton, polycotton, polypropylene.

Alternatively or in addition, such an extensible trim element can be produced by utilizing a material that is itself extensible, such as for example elastane or latex, alone or added to another material such as those listed above.

According to another advantageous characteristic, the trim element can be diffusing, in order to better diffuse the light and obtain a better visual result.

Such a diffusing trim element can be obtained by utilizing a very fine thread. The finer the thread, the more diffusing the trim element will be.

Alternatively or in addition, such a diffusing trim element can be produced by adding a diffusing covering such as paint for example.

According to an embodiment, the trim element can comprise at least one area that is both extensible and light-diffusing.

Such an area can extend over a part, the majority or the totality of the trim element.

Such an area can for example be produced by a knitted fabric utilizing a very fine thread: the stitching allowing the area to be extensible and the fineness of the thread making it possible to obtain good light diffusion capability in said area.

Alternatively or in addition, the trim element can comprise:
at least one area, called extensible area, having a greater elasticity with respect to the remainder of said trim element; and/or
at least one area, called diffusing area, having a greater light diffusion capability than the remainder of said trim element.

The at least one extensible area makes it possible to facilitate the positioning of the trim element on the framework. For example, it makes it possible to provide positioning without folding of the trim element on the framework, then holding said trim element in position.

The at least one extensible area has a greater elasticity compared to the at least one diffusing area.

At least one, in particular each, extensible area can be produced by one of the techniques described above.

At least one, in particular each, extensible area can form at least a part, or the totality, of a non-visible, or the least visible, face of the structure in a configuration of use.

The at least one diffusing area makes it possible to obtain better illumination by providing better light diffusion.

The at least one diffusing area has a greater light diffusion capability compared to the at least one extensible area.

At least one, in particular each, diffusing area can be produced by one of the techniques described above.

At least one, in particular each, diffusing area can form at least a part, or the totality, of a visible, or the most visible, face of the structure in a configuration of use.

According to preferred, but non-limitative, embodiments, the structure according to the invention can be any one of the following structures:
an illuminated box;
an illuminated sign, in particular an illuminated suspended sign;
an illuminated wall, for example a wall of an illuminated stand; or
an illuminated stand.

### BRIEF DESCRIPTION OF THE DRAWINGS

Other advantages and characteristics will become apparent on examination of the detailed description of embodiments which are in no way limitative, and from the attached drawings, in which:

FIGS. 1a and 1b are diagrammatic representations of a first example of a framework according to the invention;

FIG. 2 is a diagrammatic representation of a first example of a structure according to the invention comprising the framework in FIGS. 1a and 1b;

FIG. 3 is a diagrammatic representation of a second example of a framework according to the invention;

FIG. 4 is a diagrammatic representation of a second example of a structure according to the invention comprising the framework in FIG. 2;

FIGS. 5a and 5b are diagrammatic representations of a non-limitative embodiment of an illuminated framework tube capable of being utilized in a framework according to the invention;

FIG. 6 is a diagrammatic representation of an example of a connector capable of being utilized in a framework according to the invention;

FIG. 7 is a diagrammatic representation of an example of a connecting piece capable of being utilized in a framework according to the invention.

It is well understood that the embodiments that will be described hereinafter are in no way limitative. In particular, variants of the invention may be envisaged, comprising only a selection of the characteristics described hereinafter, in isolation from the other characteristics described, if this selection of characteristics is sufficient to confer a technical advantage or to differentiate the invention with respect to the state of the prior art. This selection comprises at least one, preferably functional, characteristic without structural details, or with only a part of the structural details if this part alone is sufficient to confer a technical advantage or to differentiate the invention with respect to the state of the prior art.

In the figures, elements common to several figures retain the same reference.

### DETAILED DESCRIPTION

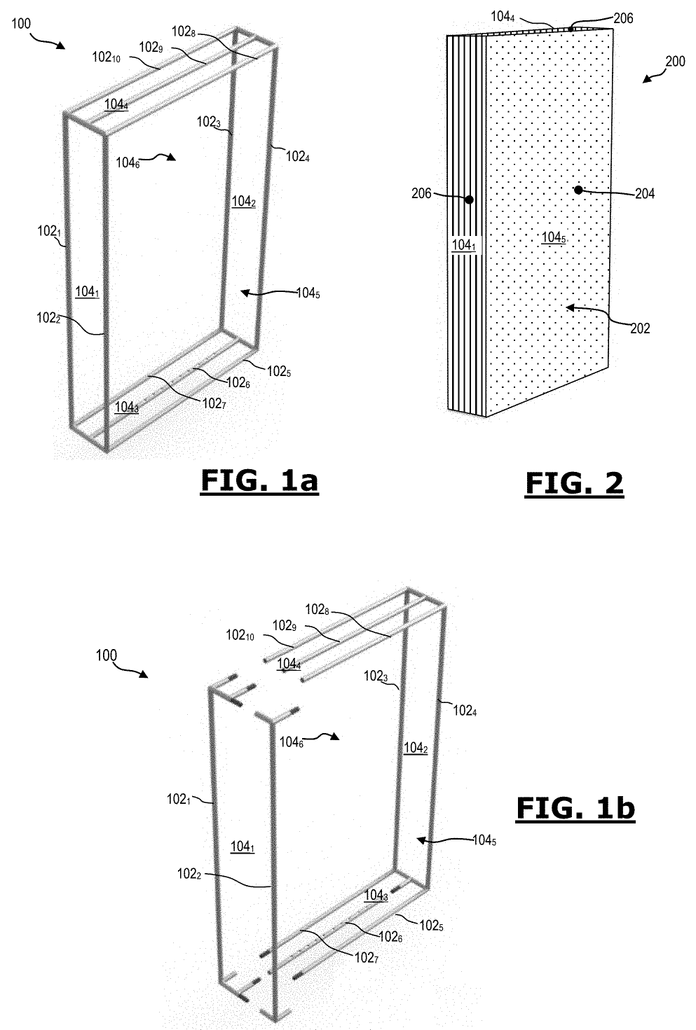

FIGS. 1a and 1b are diagrammatic representations of a first example of a framework according to the invention. The framework 100 is represented in FIG. 1a in an assembled configuration, and in FIG. 1b in a semi-assembled configuration.

The framework 100 can be used to produce an illuminated wall, for example a wall of a stand. The framework 100 can also be used to produce an illuminated box.

The framework 100 is produced by assembling rounded tubes having the same cross section: 102₁-102₁₀.

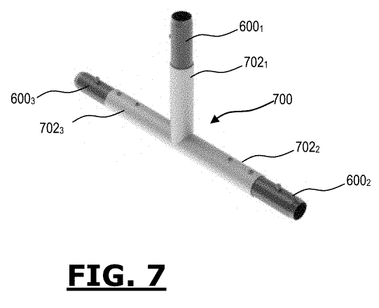

All the framework tubes 102 are assembled together by identical connectors that are independent of said tubes 102. The independent connectors can be installed and removed manually without using any tool. An example connector used for assembling the tubes 102 will be described in more detail with reference to FIG. 6.

In the configuration represented in FIGS. 1a and 1b, the framework 100 is formed by:
two vertical tubes 102₁-102₂ forming a first vertical lateral wall/face 104₁;
two vertical tubes 102₃-102₄ forming a second vertical lateral wall/face 104₂, opposite the vertical lateral wall/face 104₁;
three horizontal tubes 102₅-102₇ forming the horizontal lower wall/face 104₃;
three horizontal tubes 102₈-102₁₀ forming the horizontal upper wall/face 104₄.

The framework 100 comprises a front face 104₅ delimited by the tubes 102₂, 102₄, 102₅ and 102₈ forming the edges of said front face, and a rear face 104₆ delimited by the tubes 102₁, 102₃, 102₇ et 102₁₀ forming the edges of said rear face.

The framework tube 102₆ is an illuminated framework tube, as it comprises a light source, formed by a series of LEDs, incorporated into the thickness of said tube 102₆ so that it does not project from said tube 102₆.

The illuminated framework tube 102₆ is provided in order to light the front face 104₅ upwards from below. It is located in the lower face 104₃ at a distance from the front face 104₅, i.e. set back with respect to the framework tube 102₅ forming the edge between the lower face 104₃ and the front face 104₅.

The framework tube 102₉ is an illuminated framework tube, as it comprises a light source, formed by a series of LEDs, incorporated into the thickness of said tube 102₉ so that it does not project from said tube. The illuminated framework tube 102₉ is provided in order to light the front face 104₅, downwards from the top. It is located in the upper face 104₄ at a distance from the front face 104₅, i.e. set back with respect to the framework tube 102₈ forming the edge between the upper face 104₄ and the front face 104₅.

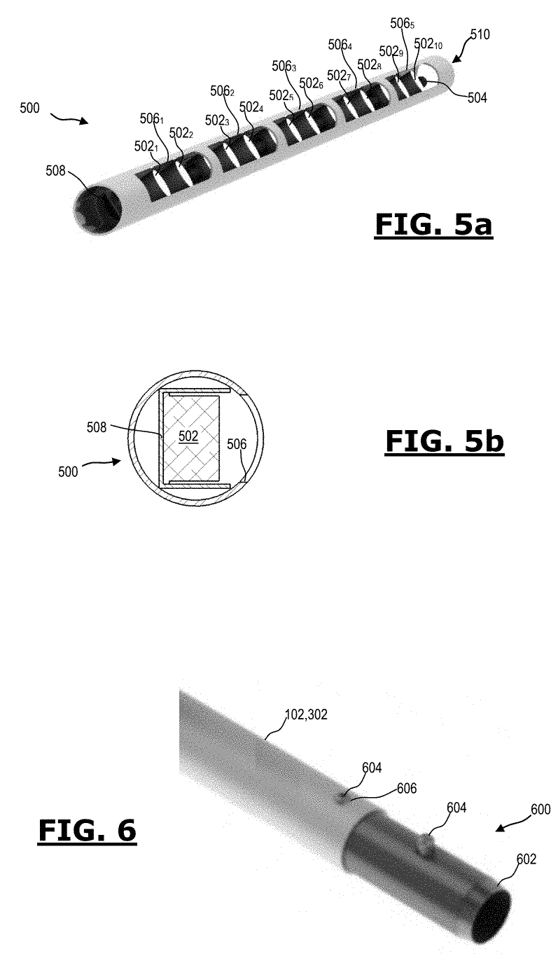

The architecture of each illuminated framework tube 102₆ and 102₉ is identical and will be described in greater detail hereinafter with reference to FIGS. 5a and 5b.

FIG. 2 is a diagrammatic representation of a first example of a structure according to the invention.

The structure 200 in FIG. 2 utilizes the framework 100 in FIGS. 1a and 1b.

The structure 200 can be an illuminated box or an illuminated wall.

In order to obtain the structure 200, a flexible trim element 202 is placed on/around the framework 100. The flexible trim element 202 covers the framework partially or totally.

In the example shown, the flexible trim element 202 totally covers the lateral faces 104₁-104₄, the front face 104₅ and the rear face 104₆ (not shown in FIG. 2), so that it forms a totally closed envelope around the framework 100. The trim element 202 can be closed by any means such as a zip fastener or a hook-and-loop fastener, etc.

In order to ensure better diffusion of the light emitted from each illuminated framework tube 102₆ and 102₉, the trim element 202 comprises an area 204, called diffusing area, covering/forming (or extending over a part or the totality of) the front face 104₅ of the structure 200 in a configuration of use.

The diffusing area 204 has a light diffusion coefficient that has a greater value with respect to the remainder of the trim element 202.

The diffusing area 204 can be produced for example by utilizing a very fine thread, for example a cotton thread, making said area able to diffuse, or by utilizing a diffusion paint deposited on said area. This diffusing area 204 can be printed and comprise a display.

Thus, the diffusion of the light emitted from the illuminated framework tubes 102₆ and 102₉ is better distributed over the front face 104₅, which allows a better result to be obtained.

In order to facilitate its placement on the framework 100, the trim element 202 comprises extensible areas 206, each one covering/forming one of the lateral walls/faces 104₁-104₄ and the rear face 104₆, which are the faces of the structure 200 that are least visible, or not visible, in a configuration of use.

Each extensible area 206 has a coefficient of elasticity that has a greater value compared to the remainder of the trim element 202.

Each extensible area 206 can be produced for example with knitted fabric by utilizing a cotton or polyester thread, or elastane or latex can optionally be added.

Thus, the flexible trim element 202 can be placed on the framework 100 easily, rapidly and without folds. In addition, the extensible areas 206 allow the trim element 202 to be better held onto the framework 100.

In particular, each extensible area 206 has
a greater elasticity compared to the diffusing area 204, and
a lower light diffusion coefficient compared to the diffusing area 204.

Each extensible area 206 can be produced from a material different to the material utilized in order to produce the diffusing area 204 and which verifies the two conditions stated above.

Alternatively, each extensible area 206 can be produced from one and the same material as the diffusing area 204. In this case, the diffusing area 204 can be treated in order to verify the two conditions stated above.

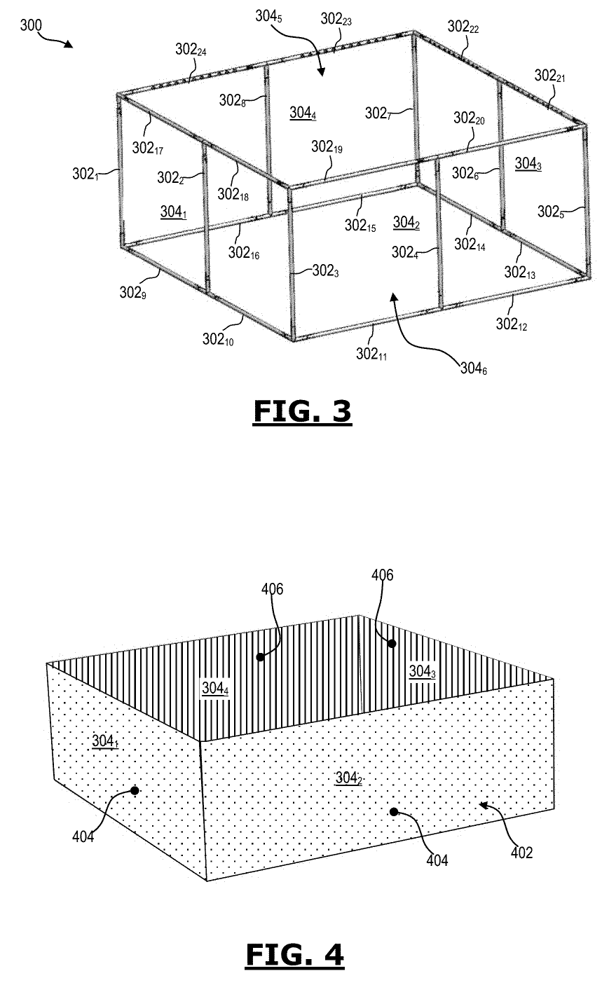

FIG. 3 is a diagrammatic representation of a second example of a framework according to the invention.

The framework 300, represented in FIG. 3, can be used to produce an illuminated suspended sign.

The framework 300 is produced by assembling rounded tubes having the same cross section: 302₁-302₂₄.

All the framework tubes 302 are assembled together by identical connectors that are independent of said tubes 302. The independent connectors can be installed and removed manually without using any tool.

In the configuration represented in FIG. 3, the framework 300 is formed by;
eight vertical tubes 302₁-302₈;
eight lower horizontal tubes 302₉-302₁₆ delimiting the framework 300 in the lower part; and
eight upper horizontal tubes 302₁₇-302₂₄ delimiting the framework 30 in the upper part. The framework 300 comprises four lateral walls/faces 304₁-304₄, an upper face 304₅ and a lower face 304₆.

In the framework 300, each of the upper horizontal framework tubes 302₁₇-302₂₄ is an illuminated framework tube, as it comprises a light source, formed by a series of LEDs, incorporated into the thickness of said tube, so that said light source does not project from said tube.

The illuminated framework tubes 302₁₇-302₂₄ are oriented for lighting downwards, i.e. towards the tubes 302₉-302₁₆.

Each illuminated framework tube 302₁₇-302₂₄ forms a part of the upper edge of a lateral face 304₁-304₄ of the framework. In other words, the illuminated framework tubes 302₁₇-302₂₄ form the upper lateral edge of the framework 300.

The architecture of each illuminated framework tube 302₁₇-302₂₄ is identical and will be described in greater detail hereinafter with reference to FIGS. 5a and 5b.

FIG. 4 is a diagrammatic representation of a second example of a structure according to the invention.

The structure 400 in FIG. 4 utilizes the framework 300 in FIG. 3.

The structure 400 can be a suspended sign that is closed upwardly and downwardly, and of which it is desired to illuminate all the faces except the upper face.

In order to obtain the structure 400, a flexible trim element 402 is placed on/around the lateral walls/faces 304₁-304₄ of the framework 300. The flexible trim element 402 covers the totality of each of the lateral faces 304₁-304₄.

In order to ensure better diffusion of the light emitted from each illuminated framework tube 302₁₇ and 302₂₄, the trim element 402 comprises four areas 404, called diffusing areas, each covering/forming (or extending over a part or the totality of) the outer surface of a lateral face 304₁-304₄, which are the most visible surfaces of the structure 400 in a configuration of use.

Each diffusing area 404 has a light diffusion coefficient that has a greater value with respect to the remainder of the trim element 402.

Each diffusing area 404 can be printed and comprise a display.

Thus, the diffusion of the light emitted from the illuminated framework tubes 302₁₇ and 302₂₄ is better distributed over the lateral outer surfaces of the structure 400, which allows a better result to be obtained.

In order to facilitate its placement on the framework 300, the trim element 402 comprises four extensible areas 406, each covering/forming (or extending over a part or the totality of) the inner surface of a lateral face 304₁-304₄, which are the surfaces of the structure 400 that are the least visible, or not visible, in a configuration of use.

Each extensible area 406 has a coefficient of elasticity that has a greater value compared to the remainder of the trim element 402.

Thus, the flexible trim element 402 can be placed on the framework 300 easily, rapidly and without folds. In addition, the extensible areas 406 allow the trim element 402 to be better held onto the framework 100.

In particular, each extensible area 406 has
a greater elasticity compared to the diffusing area 404, and
a lower light diffusion coefficient compared to each diffusing area 404.

Each extensible area 406 can be produced from a material different to the material used in order to produce each diffusing area 404 and which verifies the two conditions stated above.

Alternatively, each extensible area 406 can be produced from one and the same material as the diffusing area 404. In this case, each diffusing area 404 can be treated in order to verify the two conditions stated above.

FIGS. 5a and 5b are diagrammatic representations of a non-limitative embodiment of an illuminated framework tube.

The illuminated framework tube 500 is represented in FIG. 5a in an isometric view, and in FIG. 5b in a cross section view.

The illuminated framework tube 500 can be any illuminated framework tube described above with reference to FIGS. 1a, 1b and 3. In particular, each of the illuminated framework tubes 102₆, 102₉ and 302₁₇-302₂₄ can be similar or identical to the illuminated framework tube 500.

The illuminated framework tube 500 has a circular cross section.

A light source is inserted into the illuminated framework tube 500. In the example represented in FIGS. 5a and 5b, the light source is formed by a row of ten diodes 502₁-502₁₀, mounted in series, and supplied by a single flexible power supply cord 504, running within the illuminated framework tube 500.

In order to allow the light signal emitted by each diode 502 to pass through, the tube 500 comprises a row of five openings 506₁-506₅, provided to be distant from one another, and facing the diodes 502₁-502₁₀. In particular, each opening 506 is associated with two diodes 502 and allows the light originating from these two diodes to pass through. This architecture makes it possible to allow the light emitted by the diodes 502 to pass through, while retaining the maximum possible mechanical strength of the tube 500 that acts as a framework element.

Of course, in an alternative embodiment it is possible for each opening 506 to be associated with a single diode.

The diodes 502, as well as their optics, are arranged on a lighting support 508, having a “U”-shaped cross section. Such a lighting support 508 can be produced from aluminium.

The lighting support 508 makes it possible to facilitate the positioning of the diodes 502, to facilitate the insertion of the diodes 502 into the illuminated framework tube 500, and holds the diodes 502 in position in the framework tube 500 when said tube 500 is handled. For example, it is possible to place the diodes 502 on the lighting support 508 before inserting them into the tube 500. Once the diodes 502 are positioned on the lighting support 508, the latter can be inserted into the tube 500, for example from one end 510 by translational movement in the longitudinal direction of said tube 500.

Assembling the diodes with the lighting support, then with the tube 500, can be carried out in the factory, thus facilitating the installation of the framework on a site of use.

FIG. 6 is a diagrammatic representation of an example of a connector capable of being utilized in a framework according to the invention.

The connector 600, represented in FIG. 6, is suitable for assembling together two framework tubes 102₁-102₁₀, or 302₁-302₂₄.

The connector 600 is presented in the form of a male element, provided to be inserted into two framework tubes to be assembled: one framework tube on each of its ends. In FIG. 6, one of the ends (not shown) of the connector 600 is inserted into a framework tube 102 or 302, while the other end thereof is free and visible.

The connector 600 is presented in the form of a tube, having a cross section identical to the cross section of a framework tube, and having an outer diameter that is slightly smaller than the inner diameter of the framework tube.

In order to facilitate the insertion of the connector 600 into a framework tube, each end of said connector 600 comprises a beveled end part 602.

On the side of each of the ends thereof, the connector 600 is equipped with a pin 604, mounted on a spring, and moveable between a deployed position and a retracted position. When pressure is applied to the pin 604, it is retracted. When the pressure is released, the pin 604 is deployed. This pin 604 is provided in order to lodge in an opening 606 provided on the framework tube so that the connector 600 is held in position with respect to translational and rotational movement.

Of course, when three framework tubes are assembled together, then it is possible to utilize a connecting piece such as that shown in FIG. 7.

The connecting piece 700, in FIG. 7, is presented in a “T”-shape, capable of connecting three framework tubes together. For this purpose, each end 702₁-702₃ of the “T” receives a connector, respectively 600₁-600₃, itself connected to a framework tube.

Each arm of the “T”-shaped connecting piece has a cross section that is shaped identically to that of the connector, and of a framework tube.

Each of the connectors 600₁-600₃ can be identical to the connector 600 in FIG. 6.

Alternatively, it is possible to utilize a connecting piece with three arms, each of said arms being perpendicular to the other arms.

Each arm of such a connecting piece can have a cross section that is shaped identically to that of the connector, and of a framework tube.

Of course, the invention is not limited to the examples that have just been described, and it will be appreciated by those skilled in the art that changes and modifications may be made thereto without departing from the invention in its broader aspects and as set forth in the following claims.

1. A framework for a lighted structure, in particular a structure of the illuminated box or illuminated sign or illuminated wall type, comprising: said framework being at least partially formed by tubes, called framework tubes, assembled together demountably or detachably; and
at least one of said framework tubes, called illuminated framework tube, comprises at least one light source incorporated into said illuminated framework tube.

2. The framework according to claim 1, characterized in that it comprises several illuminated framework tubes each comprising at least one integrated light source.

3. The framework according to claim 1, characterized in that at least one, in particular each, illuminated framework tube comprises a lighting support, arranged in said illuminated framework tube, and on which is arranged the light source incorporated into said illuminated framework tube.

4. The framework according to claim 3, characterized in that the lighting support arranged in an illuminated framework tube is inserted into said illuminated framework tube in a longitudinal direction of said illuminated framework tube, in particular from one end of said illuminated framework tube.

5. The framework according to claim 1, characterized in that at least one light source, placed in an illuminated framework tube, is formed by several light emitters, in particular by several diodes.

6. The framework according to claim 5, characterized in that at least one, in particular each, illuminated framework tube comprises one or more openings, each provided facing a group of several light emitters.

7. The framework according to claim 1, characterized in that at least two framework tubes are assembled together by a detachable connector that is independent of said tubes.

8. The framework according to claim 1, characterized in that at least one framework tube is made of aluminium.

9. The framework according to claim 1, characterized in that at least one framework tube has a rounded or circular cross section.

10. A structure comprising a framework according to claim 1.

11. The structure according to claim 10, characterized in that it comprises a trim element, in particular in the form of a fabric, placed on a part or the totality of said framework.

12. The structure according to claim 11, characterized in that the trim element comprises at least one area that is extensible and light-diffusing.

13. The structure according to claim 11, characterized in that the trim element comprises:
at least one area, called extensible area, having a greater elasticity with respect to the remainder of said trim element; and/or
at least one area, called diffusing area, having a greater light diffusion capability with respect to the remainder of said trim element.

14. The structure according to claim 10, characterized in that it is an illuminated box, an illuminated sign, a wall of an illuminated stand, or an illuminated stand.
